(19) United States
(12) Patent Application Publication
(10) Pub. No.: US 2014/0046664 A1
(43) Pub. Date: Feb. 13, 2014

(54) Secure Device Pairing Using Voice Input

(71) Applicants: Shantanu Sarkar, San Jose, CA (US); Cary Bran, Seattle, WA (US); Joe Burton, Los Gatos, CA (US); Joseph Stachula, Santa Cruz, CA (US)

(72) Inventors: Shantanu Sarkar, San Jose, CA (US); Cary Bran, Seattle, WA (US); Joe Burton, Los Gatos, CA (US); Joseph Stachula, Santa Cruz, CA (US)

(73) Assignee: PLANTRONICS, INC., Santa Cruz, CA (US)

(21) Appl. No.: 13/584,460

(22) Filed: Aug. 13, 2012

(51) Int. Cl. G10L 17/00

(52) U.S. Cl. 704/246; 704/E17.003

(57) ABSTRACT

Methods and apparatuses for secure device pairing are disclosed. In one example, a user voice is received simultaneously at a first device and a second device to pair the devices.

### BACKGROUND OF THE INVENTION

Bluetooth is a wireless technology standard for exchanging data over short distances using short-wavelength radio transmissions in the ISM band from 2400-2480 MHz from fixed and mobile devices. Bluetooth uses a process called pairing to control which devices are allowed to connect to a given Bluetooth device and establish a connection without user intervention (e.g., as soon as the devices are in range). The pairing process is triggered either by a specific request from a user to pair devices, or it is triggered automatically when connecting to a service for the first time where the identity of a device is required.

Pairing typically involves some level of user interaction to authenticate the identity of the devices. Once pairing successfully completes, a bond will have been formed between the two devices, enabling the two paired devices to connect to each other in the future without repeating the pairing process.

During the Bluetooth pairing process, the two devices involved establish a relationship by creating a link key (also referred to herein as a security or pairing “token”) which is shared and stored on both devices. If a link key is stored by both devices, the devices are said to be paired. The link key is then exchanged in all subsequent transactions. A device that wants to communicate only with a paired device can cryptographically authenticate the identity of the other device to ensure it is the same device it previously paired with. Once a link key has been generated, an authenticated Asynchronous Connection-Less (ACL) link between the devices may be encrypted so that any data exchanged is protected against eavesdropping.

The identity of the devices to be paired may be authenticated using a personal identification number (PIN) code, which may be an ASCII string up to 16 characters in length, for example. If a fixed PIN is associated with a first device, a user of the second device may enter the PIN code associated with the first device into the second device. Upon receiving the correct PIN code, the second device is able to successfully authenticate the first device and the devices establish a communication link, in order to complete the Bluetooth pairing. However, manual entry of a code may be problematic as some users may have difficulty typing the code and the entry may be viewed by observers.

Many devices employ a simple numeric PIN code, such as a 4-digit PIN code for example, which is frequently fixed in memory at the device (e.g., “0000”). In particular, devices such as headsets that have a limited user interface are likely to have fixed PIN codes. With little or no user interface, devices that use a randomly generated pairing code become very cumbersome as there is no way to relay the code to the user. However, while the “0000” approach works for users/environments where secure device pairing is not important, it is problematic in environments where security is important.

Other Bluetooth devices may utilize the Secure Simple Pairing (SSP) process described in the Bluetooth Specification Revision 2.1, which is hereby incorporated by reference in its entirety, in particular, devices having a limited user interface often employ a simplified version of the “Numeric Comparison” pairing Association Model, where the simplified version is often referred to as “Just Works” pairing. In the “Numeric Comparison” model, both devices to be paired calculate a random six digit user confirmation value that only the devices know and both devices display the number on each device screen. The user compares the displayed numbers to ensure they match and presses a button on each device to confirm. Devices with a limited user interface not having a display may utilize the “Just Works” simplification, whereby user confirmation is assumed and pairing is performed without actual user confirmation of the calculated six digit number. Again, while the “Just Works” approach works for users/environments where secure device pairing is not important, it is problematic in environments where security is important.

The inventors have recognized certain security limitations in current pairing processes. The use of a fixed PIN or presumed user confirmation for device pairing is fundamentally insecure, allowing an unauthorized device to pair with a target device when the target device is in pairing mode. The ability of a Bluetooth device to connect to multiple Bluetooth devices using multipoint mode also creates security holes. For incoming calls, even if an unauthorized headset does not accept the call to the secure device it is paired to and thus remains undetected, it can still obtain call data and thus breach security.

Bluetooth security attacks include eavesdropping, unauthorized device control, unauthorized access to personal data, denial of service, and identity detection. Bluetooth devices may be subject to “Man-in-the-Middle” attacks, whereby an unauthorized device (also referred to as a rogue device) insinuates itself in the pairing process between two legitimate devices. The unauthorized device responds to both legitimate devices during the pairing process, fooling the legitimate devices into believing they have located each other. Instead, the legitimate devices are communicating with and through the unauthorized device, enabling the unauthorized device full trust of both devices. The unauthorized device is thus enabled to eavesdrop on communications and take control of the legitimate devices. Bluetooth headsets in particular are vulnerable to compromised telephony commands which hijack the functions and content of an associated mobile phone as well as compromised voice conversations.

As a result, improved methods and apparatuses for pairing of wireless devices are needed.

### BRIEF DESCRIPTION OF THE DRAWINGS

The present invention will be readily understood by the following detailed description in conjunction with the accompanying drawings, wherein like reference numerals designate like structural elements.

FIG. 1 illustrates secure pairing of a first device with a second device utilizing a voice input in one example.

FIG. 2 illustrates a detailed view of the devices shown in FIG. 1 in one example.

FIG. 3 is a flow diagram illustrating pairing of a first device with a second device in one example.

FIG. 4 is a flow diagram illustrating pairing of a first device with a second device in a further example.

FIG. 5 is a flow diagram illustrating pairing of a first device with a second device in a further example.

FIG. 6 is a flow diagram illustrating pairing of a first device with a second device in a further example.

### DESCRIPTION OF SPECIFIC EMBODIMENTS

Methods and apparatuses for device pairing are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

This invention relates to secure device pairing. In one example, a method for secure pairing of a first device with a second device includes receiving a user voice input at a first device, generating a first code from the user voice input, and transmitting the first device code to a second device to be compared to a second code, the second code generated at the second device from the user voice input.

In one example, a computer readable storage memory stores instructions that when executed by a computer cause the computer to perform a method for device pairing. The method includes entering a device pairing mode at a first device, receiving a user voice input, and generating a first code from the user voice input. The method further includes completing a pairing process with a second device following a determination of a match between the first code and a second code, the second code generated at the second device from the user voice input.

In one example, an apparatus includes a processor, a wireless communications transceiver, a user interface configured to receive a user request to enter a device pairing mode, and a microphone configured to receive a user voice input. The apparatus further includes a memory storing an application configured to generate a device authentication code from the user voice input following the user request to enter a device pairing mode.

In one example, a method for secure pairing of a first device with a second device includes receiving a user voice input operable to authenticate an identity of a user at a first device, and authenticating the first device with a second device for pairing utilizing the user voice input.

In one example, a method for secure pairing of a first device with a second device includes receiving a user voice input at a first device and generating a first code from the user voice input. The method includes receiving at the first device a second code generated at a second device from the user voice input. The received second code is compared to the first code to determine if they match.

In one example, a method for pairing of a first device with a second device includes receiving a user voice input simultaneously at a first device and a second device, generating a first code at the first device and generating a second code at the second device from the user voice input. The method further includes authenticating the first device and the second device for pairing utilizing the first code and the second code.

in one embodiment, a Bluetooth headset is securely paired with a device such as a mobile phone, PC or deskphone (also referred to as the “AG” or audio gateway, following standard Bluetooth terminology). Pairing establishes an initial association between the two devices and therefore is the primary mechanism where the security of the association needs to be established. In one embodiment, the security of this initial pairing step is increased by using the user's voiceprint. Another advantage is elimination of the need to manually type in a code for pairing. The code is generated at both the headset and the audio gateway at the same time using the voice of the user to create a voiceprint.

In one implementation, the user puts both the audio gateway and headset into pairing mode, and then speaks simultaneously into both devices. Both the headset and audio gateway capture the audio from the user and generate a set of voiceprint parameters from the audio sample. Once the voiceprint parameters are created, they are used to generate a code (which may be 4 digits, 6 digits or different) at both the headset and the audio gateway. The audio gateway sends this code to the headset, which compares it to its own internally-generated code and accepts the pairing request only if the codes match. In terms of the Bluetooth profiles, this is compliant to the profile since exactly the same information is sent over Bluetooth.

Advantageously, the pairing mechanism requires that the headset and audio gateway are in close proximity (i.e., next to each other) so that they can capture the same voice sample. It thus prevents a user outside immediate voice range from breaking into the pairing process and pairing a different device.

In a variant example, the user speaks a predefined password into both devices. Since the user is the only person who knows the password, this adds an additional level of security to the pairing. Advantageously, this allows a password to be used as the authentication mechanism for pairing. It also makes it easier to pick the exact same voice sample on both the headset and audio gateway to generate the voiceprint parameters.

In a further variant example, the voiceprint on the audio gateway (which is usually an IP-enabled device such as a PC or a mobile phone) is compared to the stored voiceprint in a back-end authentication system to ensure that the authorized user for the device is the one whose voice is being used to generate the pairing keys.

in a further variant example, the audio gateway and headset synchronize on a start point by transmitting an audio signal such as a chirp. This can be emitted by either device, and as soon as the other device hears the chirp, it starts the voice sampling for code generation. The chirp may be subsonic since the user does not need to hear it. This variant is particularly advantageous if the user desires to pair multiple devices at the same time such as a mobile phone, a PC, a headset and a key fob. The user puts them all into pairing mode and then the chirp triggers code generation.

Advantages of various methods and apparatuses described include (1) providing an increased level of security for pairing a headset to an audio gateway, (2) eliminating the need to manually enter a code, which has security advantages as well as accessibility advantages, (3) reducing remote pairing attacks by enforcing the physical proximity of the headset to the audio gateway while pairing, (5) providing increased security in pairing of devices such as headsets having a limited user interface since no numbers need to be entered at the device. In certain examples, the methods and apparatuses advantageously verify that an authorized user is the one doing the pairing by authenticating the user identity. The same user voice input may be used to authenticate the user identity.

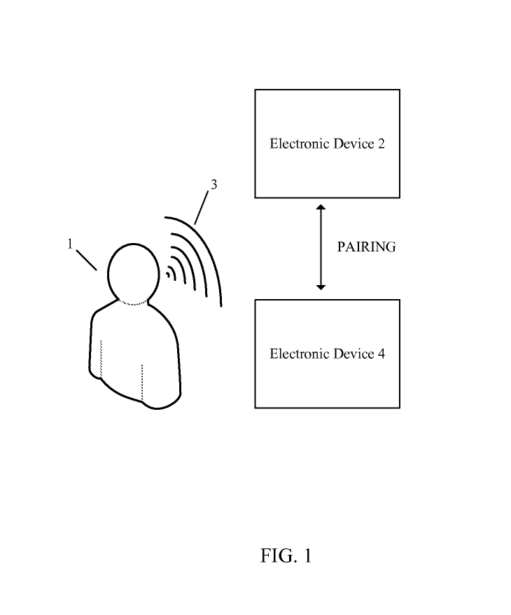

FIG. 1 illustrates secure pairing of an electronic device 2 with an electronic device 4 utilizing a voice input 3 from a user 1 in one example. In operation, a user voice input 3 is received simultaneously at electronic device 2 and an electronic device 4. A first code is generated from the voice input 3 at the electronic device 2 and a second code is generated from the voice input 3 at the electronic device 4. The electronic device 2 and the electronic device 4 are authenticated for pairing utilizing the first code and the second code. In one embodiment, the electronic device 2 transmits the first code to electronic device 4. Electronic device 4 receives the first code and compares it to the second code generated at electronic device 4. The devices are authenticated if the codes match, and the pairing process proceed to completion. In one example of a Bluetooth embodiment, the user voice input 3 is used in a Secure Simple Pairing (SSP) process, whereby the code generated from the user voice input is utilized in a Bluetooth Pass Key Entry, Numeric Comparison, or PIN device authentication process.

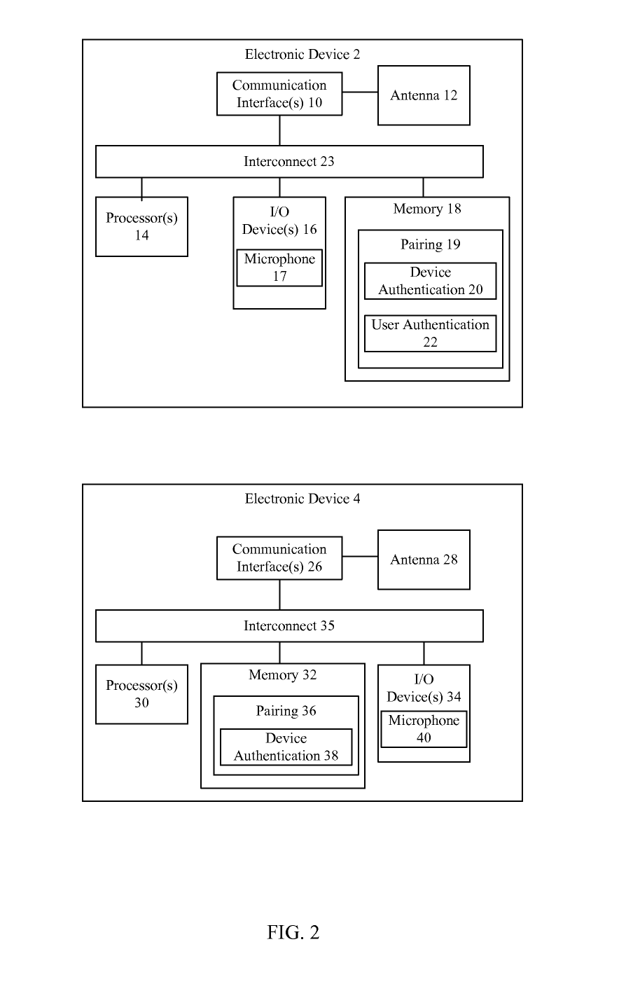

FIG. 2 illustrates a detailed view of the system shown in FIG. 1 in one example. Simplified block diagrams of the electronic device 2 and electronic device 4 are shown. In one example, the electronic device 2 and the electronic device 4 each include a two-way RF communication device having data communication capabilities. The electronic device 2 and electronic device 4 may have the capability to communicate with other computer systems via a local or wide area network.

Electronic device 2 includes input/output (I/O) device(s) 16 configured to interface with the user, including a microphone 17 operable to receive a user voice input or other audio. I/O device(s) 16 may also include additional input devices, such as a keyboard, touchscreen, etc., and one or more output devices, such as a display, speaker, etc. In some embodiments, I/O device(s) 16 may include or more of a display device, such as a liquid crystal display (LCD), an alphanumeric input device, such as a keyboard, and/or a cursor control device, and a biometric input device. I/O device(s) 16 include a user interface operable to receive a user request to enter a device pairing mode.

The electronic device 2 includes a processor 14 configured to execute code stored in a memory 18. Processor 14 executes a pairing application 19, which includes a device authentication module 20 and a user authentication module 22 to perform functions described herein. Although shown as separate applications, device authentication module 20 and user authentication module 22 may be integrated into a single application. In one example, user authentication module 22 is optional, and only device authentication module 20 is present.

Utilizing device authentication module 20, pairing application 19 is configured to generate a device authentication code from the user voice input 3 following the user request to enter a device pairing mode. In one example, the pairing application 19 is configured to generate a voiceprint from the user voice input, where the authentication code is generated from the voiceprint. In a further example, a Fourier transform of the voice input 3 is performed to obtain a distribution of voice frequencies, which are then converted to the authentication code by counting the distribution across certain frequency bands. In a further example, waveform analysis is utilized to detect the rise in inflection for certain key sounds (e.g., a “k” sound in the word “king”, where there is more stress put on the “k” which can be measured) to generate the authentication code. In a further example, the duration between silence intervals for a sentence are used as the basis for generating the authentication code, relying on the fact that every user's silence interval is unique.

In one example, the pairing application 19 is further configured to transmit a start voice receive signal to electronic device 4. The start voice receive signal is operable to enable the electronic device 4 to receive the user voice input 3 simultaneously with electronic device 2 at an electronic device 4 microphone 40 shown in FIG. 2. In one example, the start receive signal is an audio signal output at a first electronic device speaker which is detected by electronic device 4. In one example, the start voice receive signal is operable to synchronize recording of the user voice input at both electronic device 2 and electronic device 4.

Utilizing user authentication module 22, pairing application 19 is operable to confirm an identity of a user (i.e., authenticate the user) to confirm the user is an authorized user of the device. In one example, the user authentication module 22 compares the user voiceprint to a stored voiceprint to authenticate the identity of the user.

A voice print match is highly accurate. In one example, the user voice input is a predetermined user provided identifying phrase (herein also referred to as the “voice print phrase key”). The voice print match may operate by matching the test voice print phrase key against a template of the authorized user's voice characteristics, such as spectral matching, cadence, etc. In one example, the user initially inputs a predetermined voice print phrase key or keys into the voice print identification system for use as the benchmark against which all future user accesses are compared. During the authentication process, the user must speak the predetermined voice print phrase key for comparison with the stored phrase. The user response must come within an acceptable range of similarity with the pre-stored voice print phrase key. The user may be prompted with audio prompts to speak the voice print phrase key.

In one example, the user voice input is a password input, and the pairing application 19 is configured to authenticate an identity of the user by comparing the user voice input with a previously established password stored in the memory. In this example, the spoken user voice input is a fixed predetermined passphrase (also referred to herein as a “password” or “personal identification number (PIN)” that only the device and the user know. The user may be prompted with a prestored audio prompt to speak the password or personal identification number. This passphrase is then received by the microphone, converted using an A/D converter, and fed into a speech recognition (also sometimes referred to in the art as “voice recognition”) application to verify the correct phrase was spoken. Any speech recognition application/engine known in the art may be used. For example, the digitized voice samples are divided into frames of a pre-determined length. The energy of each frame is calculated and used to identify the start and end of a spoken word. Linear prediction coding may be used to produce parameters of the spoken word, and recognition features of the word are calculated and matched with reference words in a reference library. The submitted password or PIN recognized from the user speech is compared to the valid password or PIN to validate an identity of the authorized device user.

Thus, advantageously in certain examples a single user voice input is utilized to both pair the electronic devices and authenticate the user identity. The user identity may be authenticated using either voice print matching or voice recognition of a password or PIN, or both.

In one example, user authentication module 20 does the following with respect to the authentication state of the user: (1) takes in user specific data (password or voiceprint biometrics hereafter called “credentials”), (2) analyzes credentials and determines authentication status, (3) records when a successful or failed authentication occurs, (4) monitors authentication expiration time for a given user, (5) revokes authentication under specified conditions or events. User authentication module 20 operates to examine user/password data or biometric data, and generates digital credentials based on this data. In one example, the user authentication module 20 has shared data or a database for its users and compares the digital credentials received to its data.

In further examples, I/O device(s) 16 may consist of a variety of devices which can be used to establish or authenticate the identity of a user. Users authenticate themselves using passwords, ID-cards and/or biometrics to the authentication system through one or more I/O device(s) 16. Input is used to receive passwords and/or biometric data or read ID-cards. Output may display menu prompts. I/O device(s) 16 may include a device that performs biometric sensing such as fingerprint scanning.

While only a single processor 14 is shown, electronic device 2 may include multiple processors and/or co-processors, or one or more processors having multiple cores. The processor 14 and memory 18 may be provided on a single application-specific integrated circuit, or the processor 14 and the memory 18 may be provided in separate integrated circuits or other circuits configured to provide functionality for executing program instructions and storing program instructions and other data, respectively. Memory 18 also may be used to store temporary variables or other intermediate information during execution of instructions by processor 14. For example, memory 18 may include pre-stored audio prompts for output through the device speaker which prompt the user to speak his name, voice print phrase key, or password.

Electronic device 2 includes communication interface(s) 10, one or more of which may utilize an antenna 12. The communications interface(s) 10 may also include other processing means, such as a digital signal processor and local oscillators. In one example, communications interface(s) 10 include one or more short-range wireless communications subsystems which provide communication between electronic device 2 and different systems or devices. For example, the short-range communications subsystem may include an infrared device and associated circuit components for short-range communication, a near field communications (NFC) subsystem, a Bluetooth subsystem including a transceiver, or a WiFi subsystem. Interconnect 23 may communicate information between the various components of electronic device 2.

Memory 18 may include both volatile and non-volatile memory such as random access memory (RAM) and read-only memory (ROM). User authentication information, including personal identification numbers (PINs), voice print parameters and data, or other biometric data may be stored in memory 18.

Instructions may be provided to memory 8 from a storage device, such as a magnetic device, read-only memory, via a remote connection (e.g., over a network via communication interface(s) 10) that may be either wireless or wired providing access to one or more electronically accessible media. In alternative examples, hard-wired circuitry may be used in place of or in combination with software instructions, and execution of sequences of instructions is not limited to any specific combination of hardware circuitry and software instructions.

Electronic device 2 may include operating system code and specific applications code, which may be stored in non-volatile memory. For example the code may include drivers for the electronic device 2 and code for managing the drivers and a protocol stack for communicating with the communications interface(s) 10 which may include a receiver and a transmitter and is connected to an antenna 12. Communication interface(s) 10 provides a wireless interface for communication with electronic device 4.

Communication interface(s) 10 may provide access to a network, such as a local area network. Communication interface(s) 10 may include, for example, a wireless network interface having antenna 12, which may represent one or more antenna(e). In one embodiment, communication interface(s) 10 may provide access to a local area network, for example, by conforming to IEEE 802.11b and/or IEEE 802.11g standards, and/or the wireless network interface may provide access to a personal area network, for example, by conforming to Bluetooth standards. In addition to, or instead of, communication via wireless LAN standards, communication interface(s) 10 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Similarly, electronic device 4 includes communication interface(s) 26, antenna 28, memory 32, and I/O device(s) 34 substantially similar to that described above for electronic device 2. Input/output (I/O) device(s) 34 are configured to interface with the user, and include a microphone 40 operable to receive a user voice input or other audio.

The electronic device 4 includes an interconnect 35 to transfer data and a processor 30 is coupled to interconnect 35 to process data. The processor 30 may execute a number of applications that control basic operations, such as data and voice communications via the communication interface(s) 26. Processor 14 executes a pairing application 36, which includes a device authentication module 38 coordinating with and performing functions similar to pairing application 19 and device authentication module 20 at electronic device 2. In a further example, memory 32 includes a user authentication module to perform functions similar to user authentication module 22.

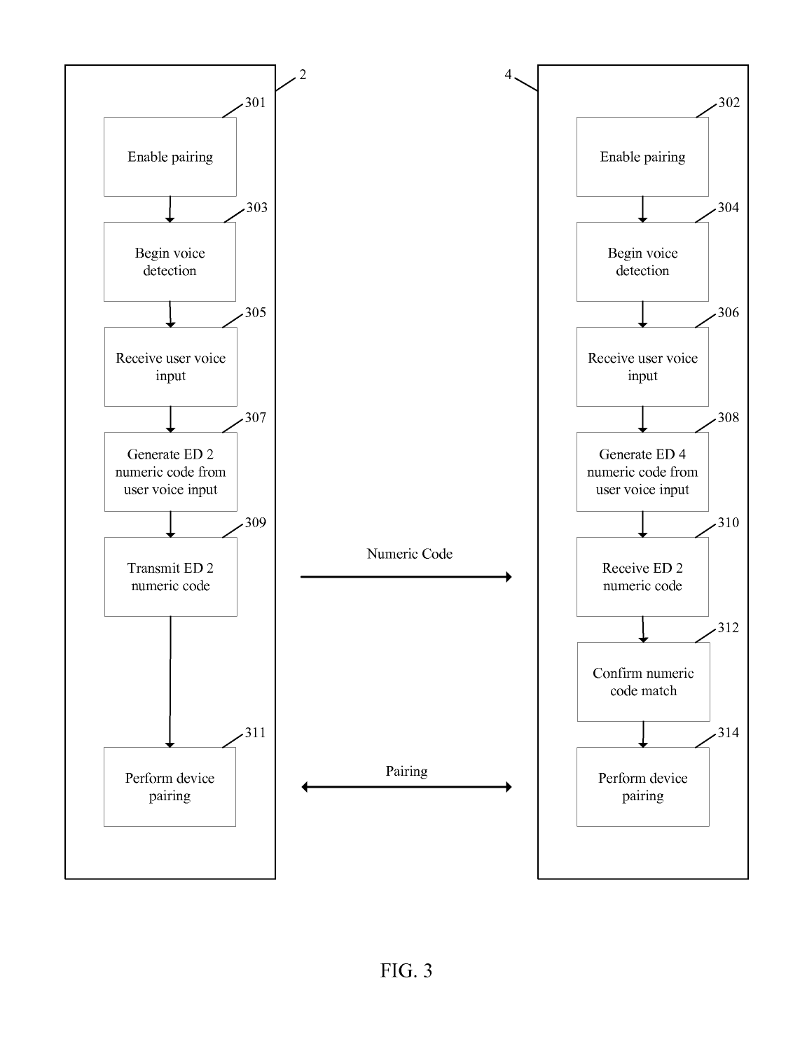

In various embodiments, the techniques of FIG. 3-6 discussed below may be implemented as sequences of instructions executed by one or more electronic systems. The instructions may be stored by the electronic device 2 or the instructions may be received by the electronic device 2 (e.g., via a network connection) or stored by the electronic device 4 or the instructions may be received by electronic device 4.

Electronic device 2 and electronic device 4 are intended to represent a range of electronic devices, for example, headsets, computer systems, tablet computers, smartphones, laptops, PDAs, cellular telephones, etc. In certain cases, such as where electronic device 2 or electronic device 4 is a wireless headset, the device may have a limited user interface (e.g., no display or reduced user input buttons). In one example, electronic device 2 and electronic device 4 are Bluetooth enabled devices such as headsets, smartphones, or tablet computers.

The specific design and implementation of the communications interfaces of the electronic device 2 and the electronic device 4 are dependent upon the communication networks in which the devices are intended to operate. In one example, electronic device 2 and electronic device 4 communicate with each other using a communication interface in accordance with the Bluetooth standard. To communicate with each other utilizing Bluetooth, electronic device 2 and electronic device 4 are paired using the techniques described herein.

In operation, if a user wishes to utilize wireless communications between electronic device 2 and electronic device 4 and the devices have not been paired for wireless communications, a pairing process is performed. For example, the electronic device 2 prompts the user to speak a pre-determined word or phrase which is detected by the device microphone. The prompt may be displayed or output at the device speaker in response to a user action, for example by requesting that the electronic device 2 and electronic device 4 be paired.

Once the electronic device 2 and electronic device 4 are authenticated, electronic device 2 and electronic device 4 complete the pairing process for wireless communications. In one Bluetooth example, the public keys are exchanged between electronic device 2 and electronic device 4. Once a device (e.g., electronic device 2) has received the public key of the peer device (e.g., electronic device 4), the devices starts to calculate the Diffie Hellman Key (DHKey). The DHKey calculation may begin prior to the devices being authenticated for pairing. Once electronic device 2 and electronic device 4 have been authenticated and the DHKey calculation is complete, the DHKey value generated is checked. The link key is then calculated from the DHKey and stored on electronic device 2 and electronic device 4. The link key is used in encrypting subsequent communications between electronic device 2 and electronic device 4. In one example, the link key is user identity secured.

FIG. 3 is a flow diagram illustrating pairing of a first electronic device 2 with a second electronic device 4 in one example. In one example, the electronic device 2 is a Bluetooth audio gateway and the electronic device 4 is a Bluetooth headset, or vice versa, and the flow diagram illustrates a Bluetooth pairing process.

At electronic device 2, a device pairing mode is enabled at block 301. At block 303, voice detection begins at electronic device 2. In one example, prior to voice detection at electronic device 2, electronic device 2 transmits a start voice receive signal to the electronic device 4 operable to synchronize reception or recording of the user voice input at both electronic device 2 and the electronic device 4.

At block 305, a user voice input is received. In one example, the user voice input is a predefined word or password. At block 307, an electronic device 2 numeric code is generated from the received user voice input. In one example, the electronic device 2 numeric code is generated by generating a voiceprint from the user voice input, and generating the electronic device 2 numeric code from the voiceprint.

At electronic device 4, a device pairing mode is enabled at block 302. In one example, electronic device 4 receives a start voice receive signal from electronic device 2 operable to enable electronic device 4 to receive the user voice input. For example, the start receive signal may be an audio signal output at an electronic device 2 speaker.

At block 304, voice detection begins at electronic device 4. At block 306, the same user voice input received at electronic device 2 is also received at electronic device 4. The user need only speak the voice input once. At block 308, an electronic device 4 numeric code is generated from the received user voice input.

At block 309, electronic device 2 transmits the electronic device 2 numeric code to electronic device 4. At block 310, electronic device 4 receives the electronic device 2 numeric code.

At block 312, electronic device 4 compares the electronic device 2 numeric code and electronic device 4 numeric code and confirms a numeric match. If there is a numeric match, at block 314, electronic device 4 proceeds with completing the pairing process with electronic device 2. At block 313, electronic device 2 proceeds with completing the pairing process with electronic device 2.

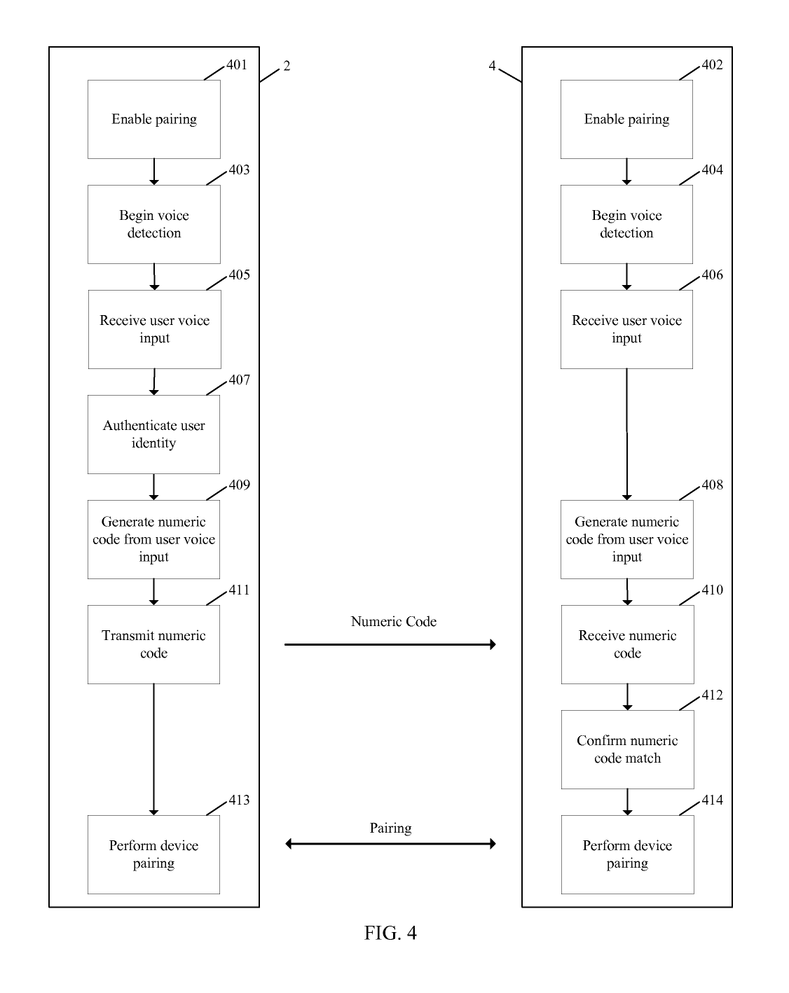

FIG. 4 is a flow diagram illustrating pairing of a first electronic device with a second electronic device in a further example. The process illustrated in FIG. 4 is substantially similar to the process shown in FIG. 3, with the exception that user identity is authenticated utilizing the user voice input. At electronic device 2, a device pairing mode is enabled at block 401.

At block 403, voice detection begins at electronic device 2. In one example, prior to voice detection at electronic device 2, electronic device 2 transmits a start voice receive signal to the electronic device 4 operable to synchronize reception or recording of the user voice input at both electronic device 2 and the electronic device 4.

At block 405, a user voice input is received. At block 407, a user identity is authenticated. In one example, the user identity is authenticated using the user voice input. In one embodiment, a voiceprint is generated from the voice input and the user is authenticated by comparing the voiceprint to a stored voiceprint. The stored voiceprint may be stored on electronic device 2, electronic device 4, or on a device remote from both electronic device 2 and electronic device 4. In one embodiment, the voice input is a password and the user authenticated by comparing the password to a previously established stored password. The stored password may reside on electronic device 2, electronic device 4, or on a device remote from both electronic device 2 and electronic device 4.

At block 409, an electronic device 2 numeric code is generated from the received user voice input. In one example, the electronic device 2 numeric code is generated by generating a voiceprint from the user voice input, and generating the electronic device 2 numeric code from the voiceprint.

At electronic device 4, a device pairing mode is enabled at block 402. In one example, electronic device 4 receives a start voice receive signal from electronic device 2 operable to enable electronic device 4 to receive the user voice input. For example, the start receive signal may be an audio signal output at an electronic device 2 speaker.

At block 404, voice detection begins at electronic device 4. At block 406, the same user voice input received at electronic device 2 is also received at electronic device 4. The user need only speak the voice input once. At block 408, an electronic device 4 numeric code is generated from the received user voice input. At block 411, electronic device 2 transmits the electronic device 2 numeric code to electronic device 4. At block 410, electronic device 4 receives the electronic device 2 numeric code.

At block 412, electronic device 4 compares the electronic device 2 numeric code and electronic device 4 numeric code and confirms a numeric match. If there is a numeric match, at block 414, electronic device 4 proceeds with completing the pairing process with electronic device 2. At block 413, electronic device 2 proceeds with completing the pairing process with electronic device 2.

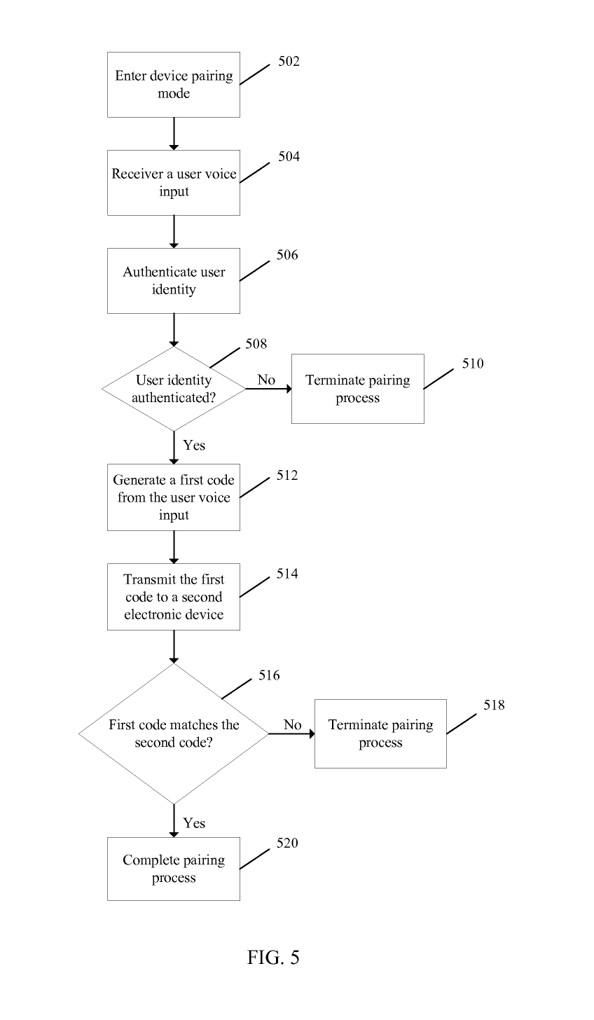

FIG. 5 is a flow diagram illustrating pairing of a first electronic device with a second electronic device in a further example. At block 502 a device pairing mode is entered at a first electronic device. At block 504, a user voice input is received. At block 506, a user identity authentication process is performed. At decision block 508, it is determined whether the user identity has been authenticated. If no at decision block 508, at block 510 the pairing process is terminated. If yes at decision block 508, a first code is generated from the user voice input at block 512.

At block 514, the first code is transmitted to a second electronic device. Alternatively, the first electronic device receives a second code from the second electronic device, where the second code was generated from the user voice input. At decision block 516, it is determined whether the first code matches the second code. If no at decision block 516, the pairing process is terminated at block 518. If yes at decision block 516, the pairing process is completed at block 520.

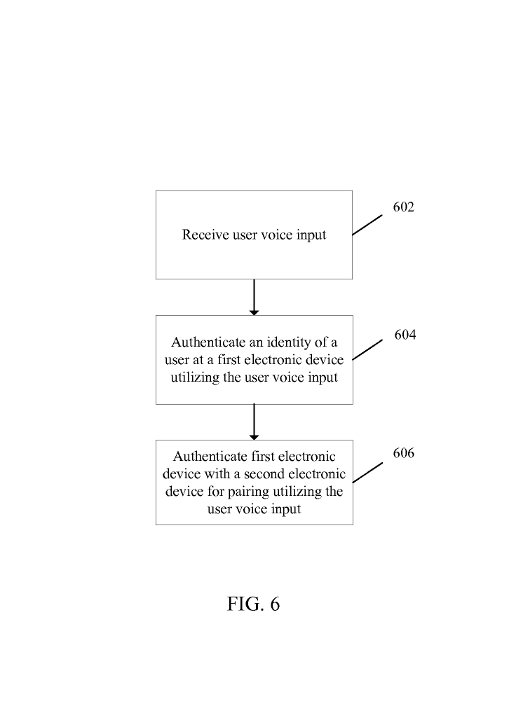

FIG. 6 is a flow diagram illustrating pairing of a first electronic device with a second electronic device in a further example. At block 602, a user voice input is received. In one example, the user voice input is a voice input received simultaneously by a first electronic device and the second electronic device. For example, the user voice input is a password. In one example, the user voice input is a voiceprint generated from a voice input. At block 604, the identity of the user is authenticated utilizing the user voice input.

At block 606, a first electronic device and the second electronic device are authenticated for pairing utilizing the user voice input. In one example, the first electronic device and the second electronic device are authenticated for pairing by generating a first code from the user voice input, and transmitting the first device code to a second electronic device to be compared to a second code, the second code generated at the second device from the user voice input. The pairing process is completed if the first device code and the second device code match.

While the exemplary embodiments of the present invention are described and illustrated herein, it will be appreciated that they are merely illustrative and that modifications can be made to these embodiments without departing from the spirit and scope of the invention. For example, while the Bluetooth wireless communications protocol is discussed in various examples, the apparatuses and methods described herein may be utilized with other wireless protocols in which device identity confirmation is required. Thus, the scope of the invention is intended to be defined only in terms of the following claims as may be amended, with each claim being expressly incorporated into this Description of Specific Embodiments as an embodiment of the invention.

What is claimed is:

1. A method for secure pairing of a first device with a second device comprising:
receiving a user voice input at a first device;
generating a first code from the user voice input; and
transmitting the first code to a second device to be compared to a second code, the second code generated at the second device from the user voice input.

2. The method of claim 1, wherein generating a first code from the user voice input comprises:
generating a voiceprint from the user voice input; and
generating the first code from the voiceprint.

3. The method of claim 2, further comprising authenticating a user by comparing the voiceprint to a stored voiceprint.

4. The method of claim 1, wherein the user voice input is a predefined password.

5. The method of claim 1, further comprising transmitting a start voice receive signal to the second device operable to enable the second device to receive the user voice input.

6. The method of claim 5, wherein the start voice receive signal is an audio signal output at a first device speaker.

7. The method of claim 1, further comprising transmitting a start voice receive signal to the second device operable to synchronize recording of the user voice input at both the first device and the second device.

8. The method of claim 1, wherein the first device is a Bluetooth audio gateway and the second device is a Bluetooth headset, or the first device is a Bluetooth headset and the second device is a Bluetooth audio gateway.

9. The method of claim 1, further comprising pairing the first device and the second device for wireless communications.

10. A computer readable storage memory storing instructions that when executed by a computer cause the computer to perform a method for device pairing comprising:
entering a device pairing mode at a first device;
receiving a user voice input;
generating a first code from the user voice input; and
completing a pairing process with a second device following a determination of a match between the first code and a second code, the second code generated at the second device from the user voice input.

11. The computer readable storage memory of claim 10, the method further comprising:
generating a voiceprint from the user voice input; and
authenticating a user identity from the voiceprint.

12. The computer readable storage memory of claim 10, wherein the user voice input is a predefined password, the method further comprising authenticating a user identity with the predefined password.

13. The computer readable storage memory of claim 10, wherein the determination of a match between the first code and a second code is a numeric comparison.

14. The computer readable storage memory of claim 10, wherein the pairing process is a Bluetooth pairing process.

15. The computer readable storage memory of claim 10, the method further comprising transmitting a start voice receive signal to the second device operable to enable the second device to receive the user voice input.

16. An apparatus comprising:
a processor;
a wireless communications transceiver;
a user interface configured to receive a user request to enter a device pairing mode;
a microphone configured to receive a user voice input; and
a memory storing an application configured to generate an authentication code from the user voice input following the user request to enter the device pairing mode.

17. The apparatus of claim 16, wherein the application is configured to generate a voiceprint from the user voice input and authenticate a user identity, wherein the authentication code is generated from the voiceprint.

18. The apparatus of claim 16, wherein the application is further configured to transmit a start voice receive signal to a device to be paired operable to enable the device to be paired to receive the user voice input.

19. The apparatus of claim 16, wherein the user voice input is a password input, and the application is further configured to authenticate an identity of the user by comparing the user voice input with a password stored in the memory.

20. A method for secure pairing of a first device with a second device comprising:
receiving a user voice input operable to authenticate an identity of a user at a first device; and
authenticating the first device with a second device for pairing utilizing the user voice input.

21. The method of claim 20, wherein authenticating the first device with a second device for pairing utilizing the user voice input comprises:
generating a first code from the user voice input; and
transmitting the first code to a second device to be compared to a second code, the second code generated at the second device from the user voice input.

22. The method of claim 21, further comprising completing a pairing process of the first device and the second device if the first code and the second code match.

23. The method of claim 20, wherein the user voice input is a voice input received simultaneously by the first device and the second device.

24. The method of claim 20, wherein the user voice input is a voiceprint generated from a voice input.

25. The method of claim 20, wherein the user voice input is a password.

26. The method of claim 20, further comprising authenticating the identity of the user using the user voice input.
